(19) United States
(12) Patent Application Publication
(10) Pub. No.: US 2005/0010577 A1
(43) Pub. Date: Jan. 13, 2005

(54) Method and apparatus for generating Web content

(75) Inventors: Baskaran Dharmarajan, Redmond, WA (US); Vikram Sardesai, Sunnyvale, CA (US)

Correspondence Address: LEE & HAYES PLLC, 421 W RIVERSIDE AVENUE SUITE 500, SPOKANE, WA, 99201, US

(73) Assignee: MICROSOFT CORPORATION, REDMON, WA (US)

(21) Appl. No.: 10/618,277

(22) Filed: Jul. 11, 2003

(51) Int. Cl. G06F 7/00

(52) U.S. Cl. 707/100

(57) ABSTRACT

A process receives a request for a Web page. The process identifies an Active Server Page associated with the requested Web page. The identified Active Server Page includes a compiled user interface template. The Active Server Page is executed to generate the requested Web page. The requested Web page is then provided to a source of the request.

### TECHNICAL FIELD

The systems and methods described herein relate to Web servers and, more particularly, to generating Web content such as Web pages.

### BACKGROUND

There are two approaches to Web application development. One approach, represented by Active Server Pages (ASPs), emphasizes rapid development over performance and is focused on HTML developers. Another approach, represented by Internet Service Application Programming Interface (ISAPI), is targeted to a more sophisticated application developer using system languages such as C and C++. ISAPI emphasizes performance, but development is typically slower. ASP is a Web server technology from Microsoft Corporation of Redmond, Washington. ISAPI is a programming interface on Internet Information Server (IIS), a Web server available from Microsoft Corporation.

The use of high performance application interfaces, such as ISAPI, to create applications typically require the use of the same interface to create associated user interfaces. Using a high performance application interface to create user interfaces is problematic because user interface developers are generally familiar with simpler declarative languages, such as HTML. Development of applications and/or user interface elements are more difficult using, for example, ISAPI. Since user interface elements are typically updated more frequently than the applications themselves, it is not desirable to use a high performance application interface to implement these frequent updates.

Accordingly, it is desirable to provide an architecture that separates development of applications from development of user interfaces.

### SUMMARY

The systems and methods described herein are used to develop Web-based applications. In one embodiment, a process receives a request for a Web page and identifies an Active Server Page associated with the requested Web page. The Active Server Page includes a compiled user interface template. The Active Server Page is executed to generate the requested Web page. The requested Web page is then provided to a source of the request.

### BRIEF DESCRIPTION OF THE DRAWINGS

Similar reference numbers are used throughout the figures to reference like components and/or features.

FIG. 1 illustrates an ASPH compiler that compiles an ASPL file into an ASPH file.

FIG. 2 is a block diagram of an example Web server.

FIG. 3 is a flow diagram illustrating an embodiment of a procedure for compiling a user interface template.

FIG. 4 is a flow diagram illustrating an embodiment of a procedure for processing an HTTP request.

FIG. 5 illustrates a general computer environment, which can be used to implement the techniques described herein.

### DETAILED DESCRIPTION

The systems and methods discussed herein use a template system to separate the business logic (e.g., the applications) from the presentation (e.g., the user interface) for developing Web-based applications. The template system is also referred to as Active Server Pages for Hotmail (ASPH). A file format contains a language table, one file index per language and structures the files as multiple code sections. The code sections contain the instructions to display the user interface elements based on the ASPH instruction set. An ASPH compiler converts the user interface templates into an ASPH file. Developers use a language, such as ASPL (Active Server Page Language), to create user interface templates, which the ASPH compiler converts into ASPH files. These ASPH files are executed by the runtime system when the application calls the high performance user interface. Execution of an ASPH file generates an appropriate Web page in, for example, HTML, XML, or WML format. Thus, using the systems and methods discussed herein, the user interface developers can program using a declarative language while the system takes advantage of the more powerful interfaces available for application development.

Although particular examples discussed herein relate to Hotmail, the systems and methods described herein can be used with any email system or any other application, such as other Web-based applications. Additionally, specific examples described herein refer to the ISAPI interface. However, alternate embodiments may utilize any high performance application interface.

Certain examples discussed herein refer to Active Server Pages (ASPs). In one embodiment, an ASP is a Web page that contains HTML as well as embedded programming code. When a Web server receives a request for an ASP page, the Web server executes the embedded programming code. As used herein, a “Web page” may contain any amount of content or information. A “Web page” may be a portion of a larger page or larger collection of information.

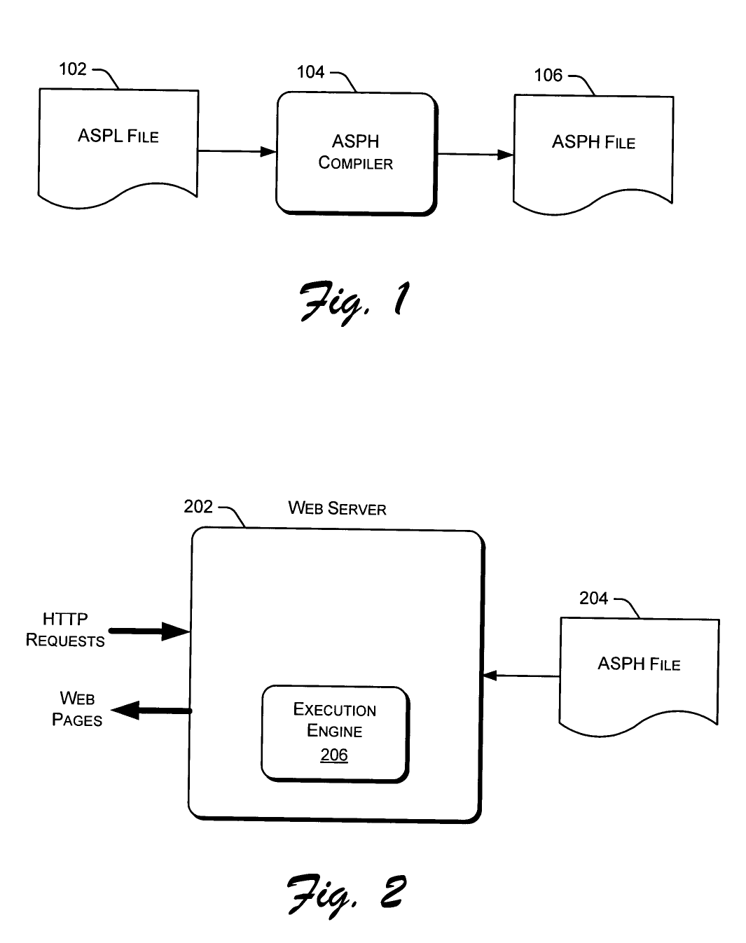

FIG. 1 illustrates an ASPH compiler that compiles an ASPL file into an ASPH file. An ASPL file 102 defines a user interface template using the ASPL language. An ASPH compiler 104 receives an ASPL file and compiles the file into a byte code format and stores the byte code data in an ASPH file 106. The compiling of the ASPL file prior to execution improves the performance of a Web server (or other computing system) as compared to interpretive systems.

User interface templates defined by ASPL file 102 include, for example, an email inbox page, a personalized home page, a new message page, and an old message page.

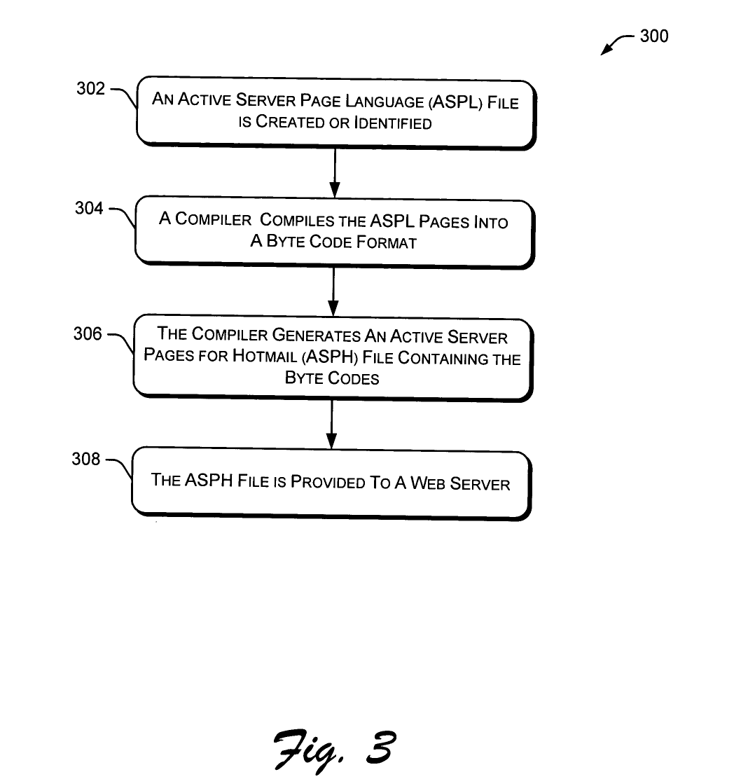

FIG. 2 is a block diagram of an example Web server 202. Web server 202 includes an interface that receives HTTP requests such as requests for Web pages received from various browser applications executing on client systems. Web server 202 also receives various ASPH files 204 that are used to generate requested Web pages. An execution engine 206 in Web server 202 executes the appropriate ASPH files in response to requests received by the Web server. Web server then uses the interface to provide the requested Web pages to the appropriate requesting browsers.

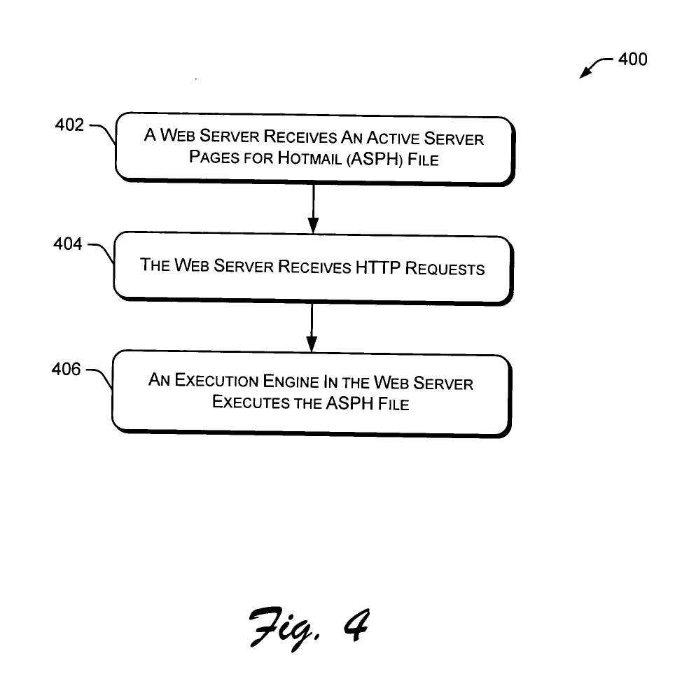

FIG. 3 is a flow diagram illustrating an embodiment of a procedure 300 for compiling a user interface template. Initially, an ASPL file is created or identified (block 302). For example, an ASPL file may be created as a user interface template by a programmer or developer. A compiler then compiles the ASPL page (or pages) into a byte code format (block 304). The compiler generates an ASPH file and stores the compiled byte code data in the ASPH file (block 306). The ASPH file is then provided to a Web server or made available to the Web server (block 308). At a later time, the Web server uses the ASPH file to generate an associated Web page requested by a client accessing the Web server.

The ASPH compiler translates the data in the ASPL files into ASPH byte codes and generates a single ASPH file (typically named “i.asph”). The compiler maintains symbol tables and file tables to maintain a mapping of names to indices and to finally put this information into the header and body of the ASPH file. During a setup phase, the compiler loads the file table and the symbol table with the variables which are known at compile time. A header file (typically defined using the C programming language) specifies the list of files in which the ISAPI code is interested. The compiler extracts the ASPL file names from this header file and loads the file information into the file table. Additionally, the compiler loads the ISAPI variable information.

During a compile phase, the compiler compiles ASPL files for each language supported. During a link phase, the compiler links together the component files and generates the i.asph file with the appropriate file headers. A few examples of the compilation of ASPL code into ASPH byte codes are discussed below to illustrate the compilation process.

Set: A set is translated into one or more Load instructions. If the value that the variable is being set to is text, then only one Load instruction is generated. However, if the value is a concatenation of text and other variables, then a series of Load instructions are generated with appropriate arguments indicating how to concatenate the parts and finally load the resulting value into the destination variable.

Text: A stream of text (e.g., just text or HTML code) is translated into a text instruction with appropriate arguments. The compiler buffers text until it sees something that is not text. At that point, the compiler generates the text instruction. Although the compiler typically processes the file line-by-line, the compiler generates a single text instruction for a stream of text.

If/Else: This is translated into a combination of Compare-Jump or Expression-Jump instructions, depending on the type of expression being tested in the if condition. If the expression is a simple expression (e.g., not involving logical operators AND and OR), it will be translated into Compare-Jump. The Compare instruction tests the expression and the jump will take care of jumping to the right location on the Boolean value of the expression. If the expression is a compound expression, then the compiler will generate an expression tree, which is a type of binary tree. The compiler then generates the Expression instruction (followed by the arguments), one of which is an array of nodes in the expression tree.

The structure of an example i.asph file is illustrated below in Table 1. In this example, each field is four bytes, unless otherwise stated. The offsets are from the beginning of the i.asph file, unless otherwise stated.

TABLE 1
Timestamp
“asph”
Number of Internal Variables
Number of Internal Built-In Variables
Number of Files

| | |
|---|---|
| Number of Files | Offset of File Name Table |
| Number of WC Entries | Offset of WC Name Table |
| Number of SO Entries | Offset of SO Name Table |
| Number of ISAPI Variables | Offset of ISAPI Variables Name Table |
| Number of Internal Variables | Offset of Internal Variables Name Table |

Number of Languages

| | |
|---|---|
| Language Code 1 | Offset of File Table 1 |
| . . . | . . . |
| Language Code n | Offset of File Table n |

File Index 1

| | |
|---|---|
| Length(2 bytes) | Filename 1 (variable) |

. . .

| | |
|---|---|
| . . . | . . . |

File Index n

| | |
|---|---|
| Length(2 bytes) | Filename n (variable) |

WC Variable Index 1

| | |
|---|---|
| Length(2 bytes) | WC Variable 1 Name (variable) |

. . .

| | |
|---|---|
| . . . | . . . |

WC Variable Index n

| | |
|---|---|
| Length(2 bytes) | WC Variable n Name(variable) |

SO Variable Index 1

| | |
|---|---|
| Length (2 bytes) | SO Variable 1 Name (variable) |

. . .

| | |
|---|---|
| . . . | . . . |

SO Variable Index n

| | |
|---|---|
| Length(2 bytes) | SO Variable n Name(variable) |

ISAPI Variable Index 1

| | |
|---|---|
| Length(2 bytes) | ISAPI Variable 1 name (variable) |

. . .

| | |
|---|---|
| . . . | . . . |

ISAPI Variable Index n

| | |
|---|---|
| Length(2 bytes) | ISAPI Variable n name (variable) |

Internal Variable Index 1

| | |
|---|---|
| Length(2 bytes) | Internal Variable 1 name (variable) |

. . .

| | |
|---|---|
| . . . | . . . |

Internal Variable Index n

| | |
|---|---|
| Length(2 bytes) | Internal Variable n name (variable) |

Language Code 1
Offset of File 1
. . .
Offset of File n
Language Code 1
Code for File 1 (variable)
. . .
Code for File n (variable)

WC (WebCourier) and SO (Special Offer) are some special types of variables which need a reverse lookup (i.e., name to internal variable index) that are used at Hotmail. In particular embodiments, a certain amount of reverse lookup is needed, such as when an external party needs to input values for internal variables through HTTP. In other embodiments, it may not be necessary to provide this reverse lookup functionality.

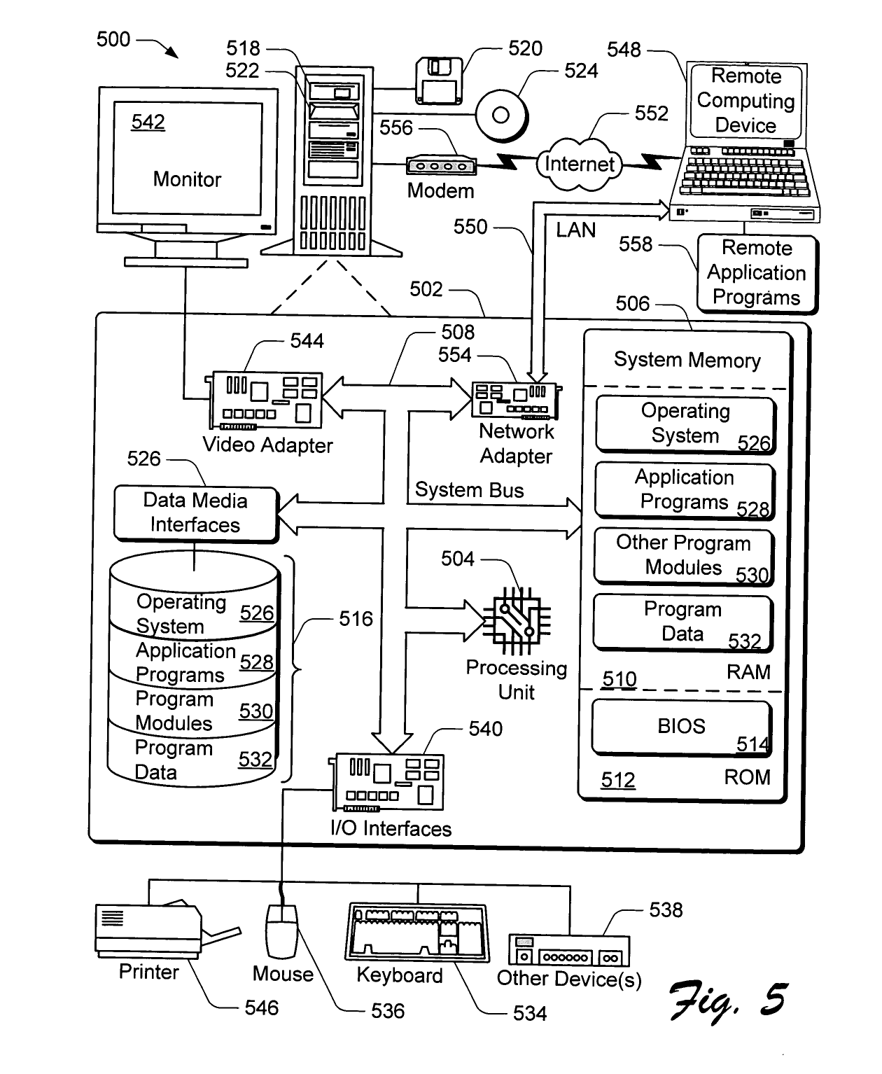

FIG. 4 is a flow diagram illustrating an embodiment of a procedure 400 for processing an HTTP request. Initially, a Web server receives or obtains access to one or more ASPH files (block 402). The Web server receives one or more HTTP requests from one or more clients coupled to the Web server (block 404). An execution engine in the Web server executes appropriate ASPH files based on the received HTTP requests (block 406). Procedure 400 is repeated for each received HTTP request.

In one embodiment, user interface templates are created using ASPL (also referred to as ASPL pages). ASPL pages contain the HTML, XML, or WML code that renders the user interface along with the presentation logic. To generate dynamic Web pages, the ASPL pages contain ASPH code segments, which are executed at runtime to dynamically generate the resulting HTML code that is finally sent to the client requesting the Web page.

The HTML code is any valid HTML instructions—it is text from the ASPH compiler's perspective. The ASPH code is enclosed within the <% and %> delimiters. The constructs supported are similar the constructs in actual Microsoft ASPL code. The following is a list of some example constructs allowed in ASPH code.

```
    1. SET: This instruction allows an ASPH variable to set to a value.
    <% set varname value %>
    varname: name of the variable
    value: value of the variable, which can be text or a concatenation of
one or more variables and text. Variables referred in the value portion
should be enclosed within ${ and }.
    e.g. <% set TitleText MSN Hotmail %>
      <% set titlelink ${server}/cgi-bin/quiklist?${usermagic} %>
    2. INCLUDE: This instruction allows an ASPL file to include
another ASPL file. This allows reuse of user interface components
separated into individual files and then used wherever needed.
    <% include filename %>
    filename: name of the file to be included
    e.g. <% include topstuff.asp %>
    3. IF/ELSE/ELSIF: This instruction allows the conditional
execution of code.
    <% if expression1 %>
    ....
    ....
    <% elsif expression2 %>
    ....
    ....
    <% elsif expression3 %>
    ....
    ....
    <% endif %>
    expression1, expression2 and expression3 are logical expressions
composed of ASPL variables and relational operators ( ==, !=) and logical
operators ( &&, ∥).
    e.g. <% if Alpha == ${Beta} %>
      <% set title SomeTextHere %>
      <% elsif Alpha == ${Beta} && Alpha != ${Gamma} %>
      <% set title SomeTextHere %>
      <% elsif Alpha == alphatext && (Alpha == ${Theta} ∥ Beta ==
    ${Gamma} ) %>
      <% set title SomeTextHere %>
      <% endif%>
```

ASPH uses indices instead of names so that each lookup is an array indexing. Since there are many classes of variables, the following types of indices are identified. The basic idea is that the ISAPI code can use these indices to set and get values for the specific variable. The ASPH compiler uses the indices table declared as enumerations in the C header files as data and derives the names out of them by removing the prefix. Thus, cAsphCabc is equivalent to the variable name “abc” to the ASPH compiler.

Where a particular variable is entirely internal to ASPL, there is no need for an explicit index that is exposed to the C code. These variables are assigned indices in the order in which they are encountered by the ASPH compiler. Where a given variable is used in the ASPL code before they are set, unless they are built-in or Site configuration variables (in which case they have a default value), the value is derived from the URL parameters.

The following table identifies various types of indices.

TABLE 2

| Type | Comment | |
|---|---|---|
| Built-In | Variables that are supported by the base ASPH Runtime. These | |
| | will always have a value, even though specific ISAPI code can | |
| | set them to a different value than the default one supplied by the | |
| | runtime. | |
| | Examples | ImageServer, IsIE5 |
| | C constant | cAsphBImageServer, |
| | | cAsphBIsIE5 |
| | Declared In | AsphSymbolTable.h |
| | Set In | AsphBuiltIn.cpp |
| ISAPI | Variables that don't have any default value unless the specific | |
| | ISAPI that is printing the ASPL file sets one. If there is no value, | |
| | the runtime may search in the URL parameters for a value and | |
| | use it. | |
| | | HasAttachements, |
| | Examples | RichTextYes |
| | C constant | cAsphCHasAttachments, |
| | | cAsphCRichTextYes |
| | Declared In | AsphSymbolTable.h |
| | Set In | Various CGIs |
| Internal | Variables that are declared and consumed with ASPL files. Note | |
| | that the variable may be set in one ASPL file and used in another | |
| | file that may include the first file. | |
| | | KillNoRadioSelected, |
| | Examples | lameheliumworkaround |
| | C constant | None |
| | Declared In | No where |
| | Set In | ASPL files |
| HRS Static | Static HRS (HRS is the Hotmail Resource System that is used | |
| Language Based | for localization) variables that are based on only language. | |
| | Examples | S01, S02 |
| | C constant | None |
| | Declared In | No where |
| | Set In | s.hrs |
| HRS Dynamic | Dynamic HRS variables that are based on only language | |
| Language Based | Examples | D01, D02 |
| | C constant | None |
| | Declared In | No where |
| | Set In | d.hrs |
| HRS Static Locale | Static HRS variables that are based on both language and | |
| Based | country. | |
| | Examples | S11, S12 |
| | C constant | None |
| | Declared In | No where |
| | Set In | s.hrs |
| HRS Dynamic | Dynamic HRS variables that are based on both language and | |
| Locale Based | country. | |
| | Examples | S11, S12 |
| | C constant | None |
| | Declared In | No where |
| | Set In | d.hrs |
| Site Configuration | Variables that represent the site configuration values. These | |
| | variables cannot be set to any other value than the ones in the | |
| | site configuration, unlike ISAPI variables. | |
| | | SiteConfig::ABCSMigrationCompleted, |
| | Examples | SiteConfig::EFormsLinkServer |
| | C | cAsphSiteConfig_{——}ABCSMigrationCompleted, |
| | constant | cAsphSiteConfig_{——}EFormsLinkServer |
| | Declared | settings_asph.h |
| | In | |
| | Set In | settings_asph_inline.h |
| File Name | Variables that represent File names. Used in include statements | |
| | and by ISAPI code to print specific files. | |
| | Examples | Attach.asp, hotmail.js |
| | C constant | cAsphFAttach, |
| | | cAsphFHotmail_js |
| | Declared In | AsphFileTable.h, |
| | | casph.config (See |
| | | WAIT:) |
| | Set In | Automatic |
| Internal Built-In | Variables set by such files that are part of the standard list that | |
| | are pre-included based on the request characteristics. | |
| | | SmallMSNLogoImage, |
| | Examples | WebMasterAcct |
| | C constant | None |
| | Declared & | ASPL files such as |
| | Set In | hotmail.asp |

As discussed above, the execution engine, which is the ISAPI runtime code that deals with response page generation, executes a single ASPH file that contains, among other things, the byte code based instructions for the various ASPL files. The ASPL files are compiled by the ASPL compiler into byte codes, each of which is a byte long and is followed by zero or more arguments. The execution engine also offers several “registers.” For example, the program counter register tracks the offset of the next instruction. The file start register keeps track of the file start locations so that relative offsets can be used. A stack is used—the value from the program counter and file start are pushed into the stack and popped from the stack when files are included from other files. The CompareResult register stores the result of the most recent comparison operation. The definition of the flag bits are:

| | |
|---|---|
| #define cComparResultEqual | 0x1//bit 1 |
| #define cComparResultNotEqual | 0x2//bit 2 |
| #define cComparResultEmpty | 0x4//bit 3 |
| #define cComparResultNotEmpty | 0x8//bit 4 |

The various byte codes and their meanings are discussed in the table below.

TABLE 3

| | | Arguments | | | |
|---|---|---|---|---|---|
| | | | Size | | What the execution engine |
| Cmd | Code | Name | (bytes) | What does it mean? | does |
| Text | t | Length | 2 | The length of the | Reads in the 2 bytes of length. |
| | | | | text to be printed | Then it simply memory copies |
| | | | | out | that many bites on to the output. |
| | | Text | Variable | The text to be | Contrast this against what ASPL |
| | | | | printed out as is | does - it copies character by |
| | | | | | character to the output, as it is |
| | | | | | looking for the angle brackets in |
| | | | | | between. |
| Print | p | Interpretation/ | 1 | This argument | Prints the value of the variable |
| | | Transformation | | specifies how to | pointed to by the index by |
| | | | | index should be | looking it up from the value |
| | | | | interpreted. See the | table. This is the equivalent of |
| | | | | interpretation/transformation | <%=%> construct. |
| | | | | table | |
| | | | | below on details. | |
| | | Index | 4 | The index of the | |
| | | | | variable whose | |
| | | | | value is to be | |
| | | | | printed. | |
| coMpare | m | Index1 | 4 | The index of the | Compares two variables and |
| | | | | first variable | updates the CompareResult |
| | | Index2 | 4 | The index of the | register. |
| | | | | second variable | |
| Jump | j | When | 1 | Gives the flags on | If any of the flags set is also set |
| | | | | which to jump | in the CompareResult register, |
| | | Offset | 4 | The relative address | the execution jumps to the offset |
| | | | | in the compiled file | in question and starts executing |
| | | | | to jump to. The | the instruction at that offset by |
| | | | | offset of the very | loading the program counter with |
| | | | | first instruction in a | the offset in question. If the |
| | | | | compiled file is | “When” parameter is 0, this is an |
| | | | | assumed to be zero. | absolute jump. Otherwise, the |
| | | | | | compiler treats the instruction as |
| | | | | | a “NO OP” and just continues |
| | | | | | with the next instruction code. |
| call | b | Iteration | 4 | The index of the | This is for the for loop |
| Back | | | | variable that holds | implementation as well. |
| | | | | the iteration count. | |
| | | Key | 4 | The index of the | |
| | | | | variable that holds | |
| | | | | the key. | |
| | | Index | 4 | The variable that | |
| | | | | holds the pointer to | |
| | | | | the call back | |
| | | | | function to invoke | |
| | | Length | 4 | The length of the | |
| | | | | statements with | |
| | | | | which the call back | |
| | | | | needs to be | |
| | | | | executed | |
| | | Code | variable | The instruction | |
| | | | | code that needs to | |
| | | | | be executed by the | |
| | | | | call back ending | |
| | | | | with a quit | |
| | | | | instruction. | |
| Load | 1 | Index | 4 | The index of the | If no dereferencing is needed, |
| | | | | variable into which | this is equivalent to setting a |
| | | | | the load is going to | variable to a literal string or |
| | | | | be performed | numerical value. Otherwise this |
| | | Interpretation/ | 1 | This argument | is equivalent to an assignment |
| | | Transformation | | specifies how to | statement where one variable |
| | | | | index should be | value is assigned to another. |
| | | | | interpreted. See the | Note that where the value is a |
| | | | | interpretation/transformation | number, an index could be |
| | | | | table | loaded into another, even |
| | | | | below on details. | though there is no explicit |
| | | Length | 4 | Length of the value | statement signifying it. |
| | | | | that is going to be | |
| | | | | loaded. | |
| | | value | Variable | The value | |
| Examine | x | Index | 4 | The index to be | The value pointed to by the |
| | | | | examined. | index is examined and the empty |
| | | | | | bit is set in the CompareResult |
| | | | | | register if it is an empty string |
| Equal | e | Index | 4 | The index of a | Test the value of the variable |
| | | | | variable | with the given index against the |
| | | Length | 4 | Length of the value | literal value. If they are equal, |
| | | | | to be tested against. | set the cCompareResultEqual |
| | | value | Variable | The literal value | bit. Otherwise set the |
| | | | | | cCompareResultNotEqual bit in |
| | | | | | the CompareResult register. |
| Add | a | Amount | 4 | The amount to be | The value pointed to by the |
| | | | | added. | index is converted into a number, |
| | | Index | 4 | The index of the | the amount added and the value |
| | | | | variable to add the | is set to point to the string |
| | | | | amount to. | representing the sum. |
| Call | c | Index | 4 | The index in the | The equivalent of include. Direct |
| | | | | file table where the | offsets are not used to allow Just |
| | | | | offset of the starting | In Time(JIT) compilation for the |
| | | | | instruction | debug mode. The execution |
| | | | | corresponding to a | engine pushes the offset of the |
| | | | | given ASPL file is | next instruction into the stack |
| | | | | stored. | and jumps to the offset pointed |
| | | | | | to by the file table at the |
| | | | | | specified index. |
| | | Interpretation/ | 1 | This specifies how | If 0, it directly indexes into file |
| | | Transformation | | the index should be | table, else it dereferences the |
| | | | | interpreted. | index to get the file index and |
| | | | | | then indexes into the file table. |
| Start | s | How | 1 | 1 if directly | For diagnostic/reverse compiler |
| | | | | invoked and 0 if | purposes. |
| | | | | not. This only | |
| | | | | describes how the | |
| | | | | compiler first | |
| | | | | encountered the | |
| | | | | file. If 1, the file | |
| | | | | ends with a quit | |
| | | | | instruction. | |
| | | | | Otherwise, return. | |
| | | Index | 4 | The file index | |
| | | Length | 2 | The length of the | |
| | | | | file. | |
| Switch | w | Index | 4 | The index of the | For dealing with internal built in |
| | | | | variable whose | variables. |
| | | | | value is switched | |
| | | | | upon. This index is | |
| | | | | expected to point to | |
| | | | | another index. | |
| | | Length | 2 | Length of the offset | |
| | | | | array. | |
| | | OffsetArray | Variable | The list of index | |
| | | | | value-offset value | |
| | | | | pairs. If the value in | |
| | | | | the switch index is | |
| | | | | equal to the index | |
| | | | | value of the pair, | |
| | | | | the execution jumps | |
| | | | | to the specified | |
| | | | | offset. | |
| Return | R | | | | The stack is popped and the |
| | | | | | offset stored there is loaded into |
| | | | | | the program counter. |
| Quit | q | | | | Stops interpreting any further |
| | | | | | instructions. |

The bits of each value are defined by the following table.

TABLE 4

| Bit | Name | Meaning |
|---|---|---|
| 0 | Dereference | If 0, the value is a literal |
| | | and can be loaded directly. |
| | | Otherwise, the value |
| | | contains an index. The |
| | | value of the contained index |
| | | should be operated on. |
| 1-3 | Transformation | 000 - none |
| | | 001 - URL encode |
| | | 002 - HTML encode |
| 4 | Concatenate | Concatenate to the value of |
| | | the index being loaded into. |
| | | Meaningful only for the |
| | | load instruction. If 0, the |
| | | load will assign this as the |
| | | new value. Otherwise, it |
| | | will do the interpretation |
| | | and then concatenate the |
| | | resultant value to the |
| | | existing index value. |

There are many special situations that are encountered by the ASPH system. These situations are generally dealt with by using built-in callbacks. These callbacks are described in the following sections. In addition to the callbacks below, internal built-in variables are dealt with using the switch statement. In ASPL, AsplInclude files such as hotmail.asp were printed before any ASPL file was printed once per each ISAPI in the ASPL constructor, whether needed or not. Also, these files contain a large number of set statements, some of which are for variables that are used in one or two places and others that are unused. So, in ASPH, these variables are classified as internal built-in, meaning, these variables derive their built-in default value from one of the Asplinclude files. So, hotmail.asp is compiled with a switch statement at the beginning. Based on which variable is being used in the ASPL page, if the variable is an internal built-in variable, the runtime executes the appropriate AsplInclude file, such as hotmail.asp after loading the index of the variable being loaded into cAsphBInternalBuiltInVariableToSwitchOn. The switch statement switches on this variable and in each case takes to the offset where the load statement for the variable whose default value is being looked up resides. The ASPL compiler inserts a quit after every load statement so that the file execution of hotmail.asp ends after the loading of the default value into the internal built in variable. Note that once loaded, the file doesn't have to be executed again for the same variable, as the value is loaded into the internal variable tables of the ASPH runtime.

The following table identifies multiple callbacks that can be used by the systems and methods described herein.

TABLE 5

| Call back | Parameter | What it holds | Comments |
|---|---|---|---|
| ISAPI | Iteration | The index of the variable | When you have something |
| Callback | | representing the iteration of the | like: |
| | | FOR loop. | <% for folder in folders %> |
| | Key | The key string. | <%=folder%> |
| | Call back | cAsphCCallback | <%endfor%> |
| | Index | | The index of the variable |
| | Code | The statements included within | “folder” goes into Iteration. |
| | Length | the FOR loop. | The string “folders” is |
| | Code | The compiled byte codes for the | pointed to by Key. The code |
| | | statements included within the | length is the length of the |
| | | FOR loop. | print statement to print the |
| | | | value of count, namely, 6. |
| | | | Note that the actual call back |
| | | | for the loop has to be set by |
| | | | the ISAPI code by the |
| | | | SetCallback() call. Also, once |
| | | | called, the call back logic |
| | | | may do whatever it deems it |
| | | | needs to do. |
| Range | Iteration | The index of the variable | When you have something |
| Callback | | representing the iteration count | like: <% for count in |
| | | of the FOR loop. | Range:10;−1;1 %> |
| | Key | The Range string of format: | <%=count%> |
| | | “Range: | <%endfor%> |
| | | Start; Increment/Decrement; End” | The index of count goes into |
| | Call back | cAsphBRangeCallback | Iteration. The string |
| | Index | | “Range:10;−1;1” is pointed to |
| | Code | The statements included within | by Key. And the code length |
| | Length | the for loop. | is the length of the print |
| | Code | The compiled byte codes for the | statement to print the value of |
| | | statements included within the | count, namely, 6. |
| | | FOR loop. | |
| HRS | Iteration | Don't care. | Since HRS compound strings |
| Range Set | Key | Don't care. | may contain variable names, |
| up | Call back | cAsphBHrsOrdinalSetupCallback | whose indices cannot be |
| Callback. | Index | | known until the ASPL files |
| | Code | The length of the HRS ordinal | are compiled, the compiler |
| | Length | array. | checks with HRS and |
| | Code | The compiled byte codes for the | converts the variable names |
| | | statements included within the | to indices. Since the HRS file |
| | | FOR loop. | cannot be changed at that |
| | | | point, the compiler puts in |
| | | | this call to load the variable |
| | | | indices (by order). The HRS |
| | | | compound strings refer to |
| | | | variables by ordinal numbers |
| | | | (in the order they appear in |
| | | | the English string). |
| Variable | Iteration | The index of the variable that | Mainly to facilitate xincludes, |
| Filename | | will hold the resultant file index | the compiler uses the variable |
| Callback | Key | The index of the variable that | file name callback to get the |
| | | holds the file name as a string. | index of a name such as |
| | Call back | cAsphBVariableFileNameCallback | wc_${_lang}${country}.asp. |
| | Index | | After loading a variable with |
| | Code | 0 | the string representing the |
| | Length | | pattern wc_followed by the |
| | Code | None | user's language and country |
| | | | and ending with .asp, the |
| | | | compiler inserts a call to look |
| | | | up the file index for the name |
| | | | and includes that index. |
| Atoi | Iteration | The index of the variable that | This is used to implement the |
| Callback | | will hold the resultant value. | <%=$var%> construct. In this |
| | Key | The index of the variable that | case, var is loaded with the |
| | | holds the index number as a | index of the variable it |
| | | string. | contains in the string form, |
| | Call back | cAsphBAtoiCallback | such as “33777743.” When |
| | Index | | the dereferencing needs to |
| | Code | 0 | happen, the compiler inserts |
| | Length | | an atoi callback to get the |
| | Code | None | integer value of the string, |
| | | | and use it as a variable index |
| | | | to lookup the value, which is |
| | | | set into variable represented |
| | | | by the iteration parameter. |
| Pipe | Iteration | The index of the variable that | This is used to implement the |
| Callback | | will hold the resultant value. | <%=\|var%> construct. In this |
| | Key | The index of the variable that | case, var is loaded with the |
| | | holds the list of pipe separated | index of the variable it |
| | | index numbers as a string. | contains in the string form, |
| | Call back | cAsphBPipeCallback | such as |
| | Index | | “33777743\|33777748” When |
| | Code | 0 | the dereferencing needs to |
| | Length | | happen, the compiler inserts |
| | Code | None | an pipe callback to get the |
| | | | integer value of the string, |
| | | | and use it as a variable index |
| | | | to lookup the value, which is |
| | | | set into variable represented |
| | | | by the iteration parameter as a |
| | | | list of string values each |
| | | | seperated by a new line. |
| Lookup | Iteration | The index of the variable that | The variables wcid and soid |
| Variable | | will hold the resultant variable | are used both ways, namely |
| Name | | value. | as <%=wcid%> and |
| Callback | Key | The index of the variable that | <%=$wcid%>. Therefore, the |
| | | holds the name of the variable | atoi callback cannot be used |
| | | to lookup. | to deference <%=$wcid%>. |
| | Call back | cAsphBLookupVarNameCallback | So, this callback was |
| | Index | | invented. Here, the system |
| | Code | 4 | looks up the index of the |
| | Length | | name contained in wcid |
| | Code | The index type to lookup, | (usually a wc content |
| | | currently cAsphCwcid and | provider name) and sets the |
| | | cAsphCsoid supported. | value of that variable name |
| | | | into the iteration parameter, |
| | | | which the compiler can |
| | | | display with additional code. |

FIG. 5 illustrates a general computer environment 500, which can be used to implement the techniques described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing device in the form of a computer 502. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown), a magnetic disk drive 518 for reading from and writing to a removable, non-volatile magnetic disk 520 (e.g., a “floppy disk”), and an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternatively, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 504 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546 which can be connected to computer 502 via the input/output interfaces 540.

Computer 502 can operate in a networked environment using logical connections to one or more remote computers, such as a remote computing device 548. By way of example, the remote computing device 548 can be a personal computer, portable computer, a server, a router, a network computer, a peer device or other common network node, game console, and the like. The remote computing device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a request for a Web page;
identifying an Active Server Page associated with the requested Web page, wherein the Active Server Page includes a compiled user interface template;
executing the Active Server Page to generate the requested Web page; and
providing the requested Web page to a source of the request.

2. A method as recited in claim 1 wherein the user interface template has been compiled into a byte code format and the Active Server Page contains the byte codes.

3. A method as recited in claim 1 wherein the user interface template contains HTML code.

4. A method as recited in claim 1 wherein the user interface template contains logic related to displaying information.

5. A method as recited in claim 1 wherein the Active Server Page includes a plurality of compiled user interface templates.

6. One or more computer-readable memories containing a computer program that is executable by a processor to perform the method recited in claim 1.

7. A method comprising:
identifying a plurality of user interface templates associated with a Web-based application;
compiling each of the plurality of user interface templates into a single file containing a plurality of byte codes, wherein the byte codes are capable of being executed by an execution engine; and
executing the plurality of byte codes when the Web-based application is executed.

8. A method as recited in claim 7 wherein the plurality of byte codes include callback codes that call into the Web-based application code.

9. A method as recited in claim 7 wherein the plurality of byte codes are executed by an execution engine in a Web server.

10. A method as recited in claim 7 wherein the plurality of byte codes are contained in an Active Server Page.

11. A method as recited in claim 7 wherein the byte codes include logic related to displaying information.

12. One or more computer-readable memories containing a computer program that is executable by a processor to perform the method recited in claim 7.

13. A method comprising:
creating a plurality of user interface templates associated with a Web-based application, wherein the plurality of user interface templates are created using an Active Server Page Language;
compiling the plurality of user interface templates into a plurality of byte codes; and
storing the plurality of byte codes associated with the plurality of user interface templates in a single file, wherein the byte codes are capable of being executed by an execution engine in a Web server.

14. A method as recited in claim 13 further comprising executing the plurality of byte codes when the Web-based application is executed.

15. A method as recited in claim 13 wherein the plurality of byte codes include callback codes that call into the Web-based application code.

16. A method as recited in claim 13 further comprising executing a portion of the plurality of byte codes when the Web-based application is executed.

17. One or more computer-readable memories containing a computer program that is executable by a processor to perform the method recited in claim 13.

18. An apparatus comprising:
an interface to receive requests for Web pages and to send responses to the received requests; and
an execution engine coupled to the interface, wherein the execution engine is configured to identify an Active Server Page associated with a request for a Web page and to identify user interface template information contained in the Active Server Page, wherein the execution engine is further configured to execute the Active Server Page to generate the requested Web page and to provide the requested Web page to a source of the request.

19. An apparatus as recited in claim 18 wherein the Active Server Page contains a plurality of byte codes associated with a plurality of user interface templates.

20. An apparatus as recited in claim 19 wherein the execution engine executes the byte codes associated with the request.

21. An apparatus comprising:
means for identifying a plurality of user interface templates associated with a Web-based application;
means for compiling each of the plurality of user interface templates into a single file containing a plurality of byte codes, wherein the plurality of byte codes are capable of being executed by an execution engine; and
means for executing at least a portion of the plurality of byte codes when the Web-based application is executed.

22. An apparatus as recited in claim 21 wherein the byte codes are contained in an Active Server Page.

23. An apparatus as recited in claim 21 wherein the byte codes include logic related to displaying information.

24. One or more computer-readable media having stored thereon a computer program that, when executed by one or more processors, causes the one or more processors to:
create a plurality of user interface templates associated with a Web-based application, wherein the plurality of user interface templates are created using an Active Server Page Language;
compile the plurality of user interface templates into a plurality of byte codes; and
store the plurality of byte codes in a single file, wherein the byte codes are capable of being executed by a Web server.

25. One or more computer-readable media as recited in claim 24 wherein the one or more processors further execute at least a portion of the byte codes when the Web-based application is executed.

26. One or more computer-readable media as recited in claim 24 wherein the plurality of byte codes include at least one callback code that calls into the Web-based application code.
